(19) United States
(12) Patent Application Publication
(10) Pub. No.: US 2013/0132107 A1
(43) Pub. Date: May 23, 2013

(54) BROWSING A COLLECTION OF FEDERATED CLINICAL DOCUMENTS

(71) Applicant: Jeremy Kohansimeh, New York, NY (US)

(72) Inventor: Jeremy Kohansimeh, New York, NY (US)

(73) Assignee: International Business Machines Corporation, Armonk, NY (US)

(21) Appl. No.: 13/303,043

(22) Filed: Nov. 22, 2011

(51) Int. Cl. G06Q 50/22

(52) U.S. Cl. 705/2

(57) ABSTRACT

Embodiments of the inventive subject matter include systems, methods and computer program products for navigating clinical documents associated with health care visits. Clinical documents for a patient are obtained. The clinical documents are documents associated with a plurality of care visits by the patient. The clinical documents are analyzed in order to determine importance ratings for the care visits. A timeline is displayed where the timeline includes graphical elements representing the care visits. The graphical elements are displayed on the timeline in accordance with a time of the care visit and the importance rating of the care visit.

### BACKGROUND

Embodiments of the inventive subject matter generally relate to the field of computing systems and, more particularly, to browsing collections of federated clinical documents maintained by one or more computer systems.

A problem that physicians often come up against when working with a collection of clinical information is how to get a good understanding of a patient's overall condition and episodes of care when presented with a collection of electronic clinical documents that have been gathered from many different care delivery organizations. Systems currently available within care delivery organizations and Health Information Exchanges (HIEs) typically provide very limited search capabilities for clinical documents by defining a strongly-controlled vocabulary of document metadata that can be used as search query terms. There also exist systems that will do a deep parsing of the clinical documents to get an understanding of what are the important clinical information of which a treating physician should be aware (allergies, diabetes, history of heart disease, etc), but these systems typically hide from the physician what they have considered to be irrelevant information about the patient in the context of care delivery. Additionally, these summarization features are typically only available after integrating with a full-fledged Electronic Medical Records (EMR) application. Summarization is necessary because a physician would be overwhelmed with information if it all was presented at once. However, with such summarization, there is a risk that potentially important information has been omitted. Thus there may be important information that the physician may never be made aware of because the physician is forced to trust the system and typically doesn't have the time to manually go through the clinical documents.

### SUMMARY

Embodiments of the inventive subject matter include systems, methods and computer program products for navigating clinical documents associated with health care visits. Clinical documents for a patient are obtained. The clinical documents are documents associated with a plurality of care visits by the patient. The clinical documents are analyzed in order to determine importance ratings for the care visits. A timeline is displayed where the timeline includes graphical elements representing the care visits. The graphical elements are displayed on the timeline in accordance with a time of the care visit and the importance rating of the care visit.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating elements of a system for browsing a collection of documents.

FIG. 2 is a flowchart illustrating a method for browsing a collection of documents.

FIG. 3 depicts an example timeline display.

FIG. 4 is a block diagram illustrating elements of an example computer system.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

In general, the embodiments of the invention provide a novel means for a user to browse large collections of documents. In some embodiments, the documents may be related to health care visits of a patient. A timeline is presented, and documents related to a health care visit are represented by graphical elements on the timeline. Characteristics of the graphical element represent aspects of the healthcare visit. For example, the size of the graphical element may represent an importance of the visit, while the color of the graphical element may represent other attributes of the visit such as the location of the visit, the healthcare facility, physician specialty, or source healthcare provider system. A user can determine using the aspects of the graphical element whether or not the documents associated with the visit indicated by the graphical element are of further interest.

Although the discussion of the inventive subject matter is provided in the context of browsing documents related to healthcare visits, those of skill in the art having the benefit of the disclosure will appreciate that the inventive subject matter described herein could be applied to browsing documents in other contexts.

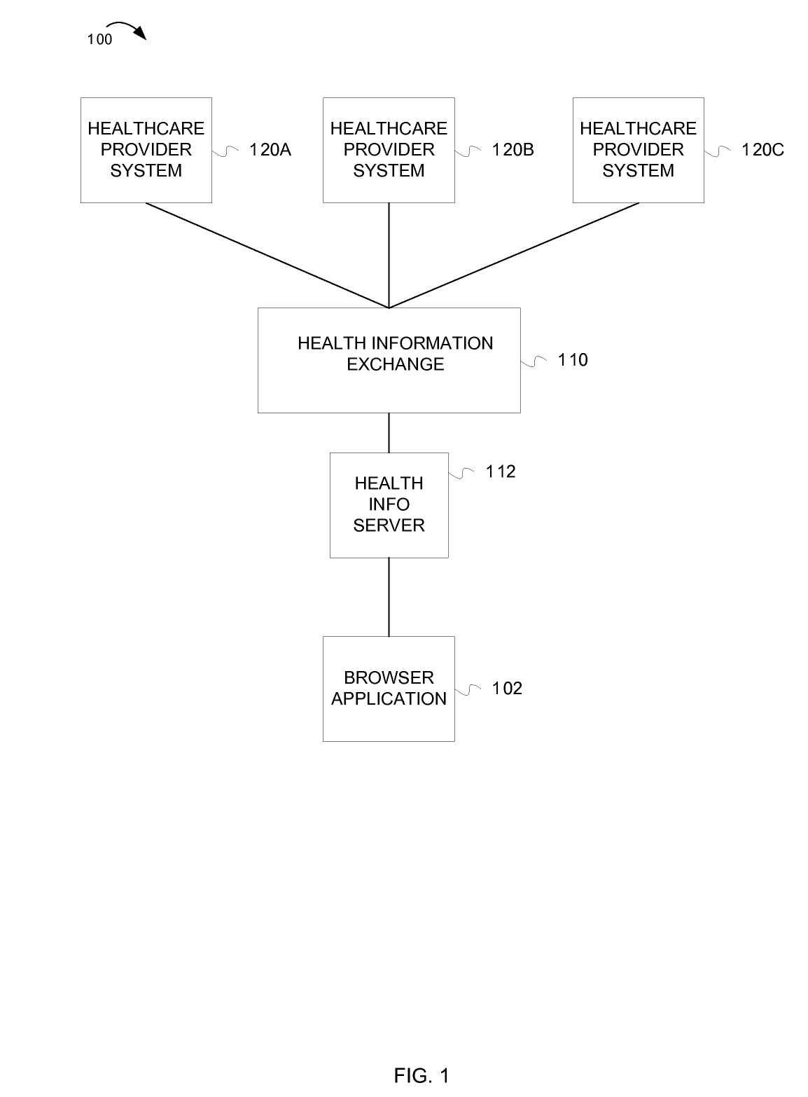

FIG. 1 is a block diagram illustrating elements of a system 100 for browsing a collection of documents. In some embodiments, system 100 includes a browser application 102, Health Information Exchange (HIE) 110, and healthcare provider systems 120. A healthcare provider system 120 may be any system capable of creating or maintaining electronic medical records (EMRs) for a patient. Such systems may be used by hospitals, clinics, emergency medical assistance providers, individual physicians and others involved in providing healthcare to patients. An EMR comprises one or more data structures that include data relevant to the medical history of a patient. EMR data may include data identifying the patient, treating physician or practitioner, test results, diagnoses, physician or practitioner notes, procedures and other data related to the health or medical history of a patient.

Healthcare provider systems 120 may use HIE 110 to exchange data with other systems 120 and server 112. In general, HIE 110 comprises a system and network infrastructure that supports the exchange of health information between disparate systems while preserving the meaning of the data exchanged. Thus systems that communicate through HIE 110 can share information even despite the fact that the information may be stored in different formats on the various healthcare provider systems 120. In addition to supporting information exchange, HIE 110 may provide security and authorization functions to protect the confidentiality of data exchanged through HIE 110.

Health information server 112 receives requests for health information for one or more patients, and uses HIE 110 to obtain EMRs for the one or more patients. For example, health information server 112 may, in response to a request for patient information from browser application 102, gather EMRs associated with the patient from various healthcare provider systems 120 coupled through HIE 110. In some embodiments, the data gathered for the patient may then be displayed to a user of browser application 102.

Browser application 102 provides a user interface for requesting healthcare information for a patient and for displaying the healthcare information to a user. As discussed above, the healthcare information may be displayed in a timeline format, with graphical elements such as circles used to represent individual healthcare visits by a patient. The size and color of the graphical element may be used to convey information such as an importance of the visit and the organization providing the health care during the visit.

In some embodiments, browser application 102 may be a standalone application. In alternative embodiments, the functionality provided by browser application 102 may be integrated with other systems used to provide healthcare information. Browser application 102 may execute on many different types of computing systems, examples of which include a personal computer, laptop computer, tablet computer, mobile phone or any other processor based system.

It should be noted that in some embodiments, HIE 110 is not present and health information server 112 may communicate directly with healthcare provider systems 120. For example, in some embodiments, healthcare provider systems 120 may provide a uniform data interface and data format. In such embodiments, the data translation and transformation provided by HIE 110 is not necessary. In further embodiments, health information server 112 may provide data translation or transformation functions. In still further alternative embodiments, browser application 102 may interface directly with a single healthcare provider system 120, in which case HIE 110 and health information server 112 are not needed.

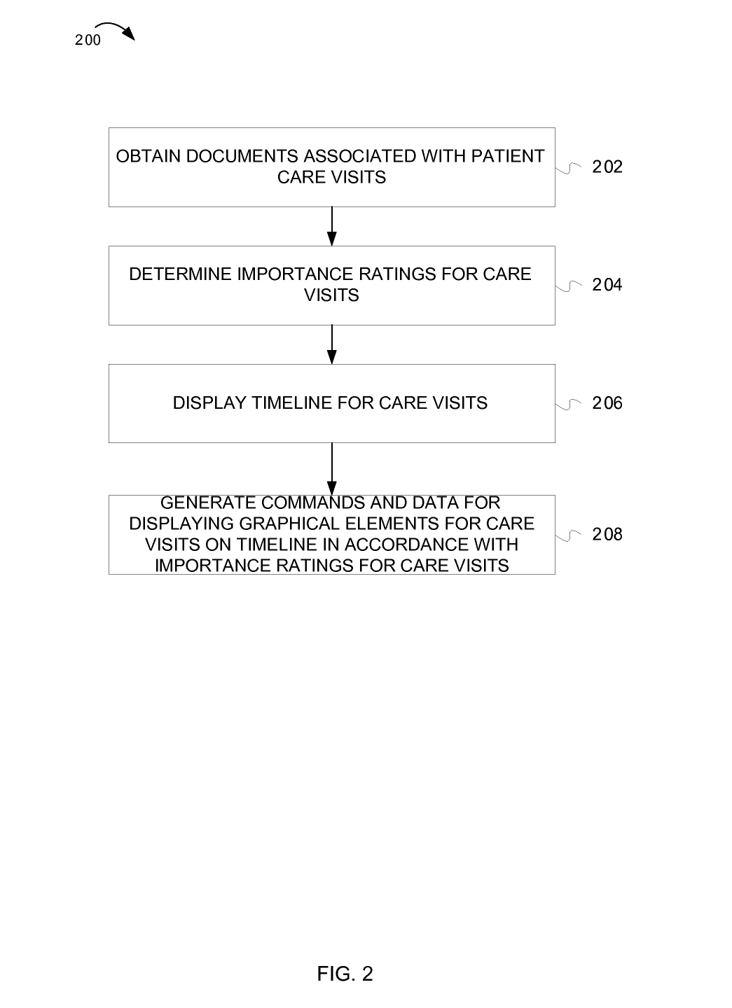

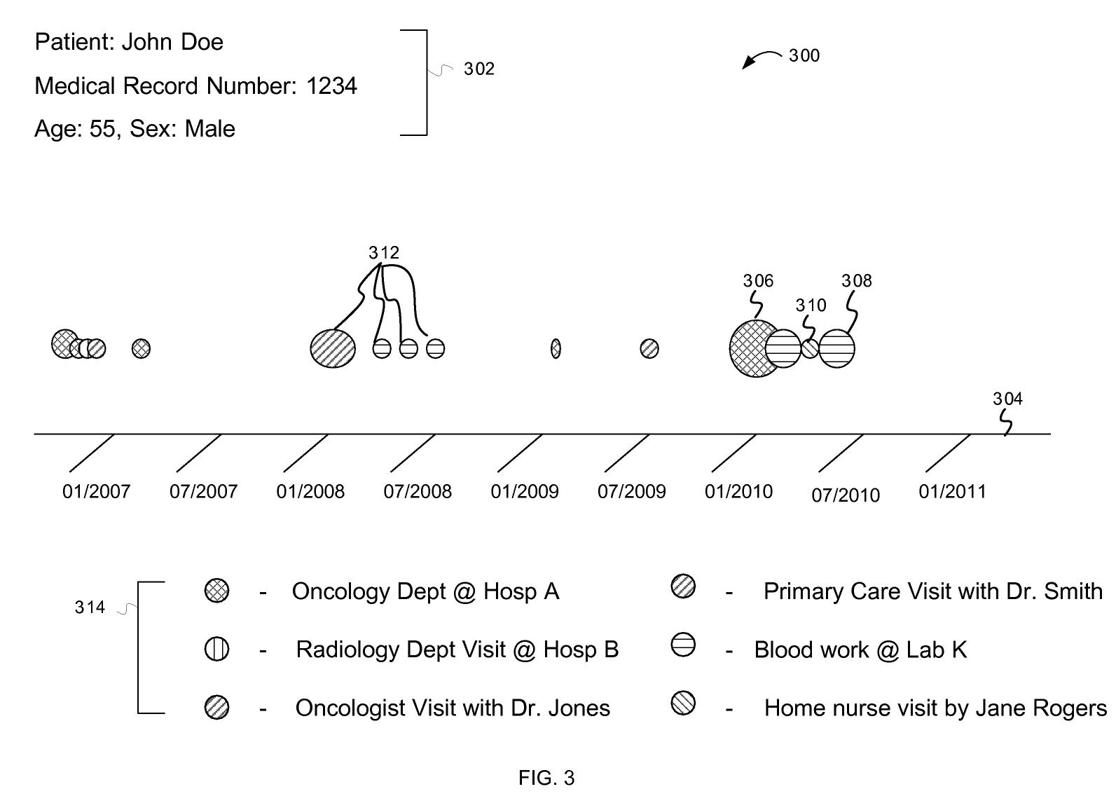

Further details on the operation of system 100 are provided below with reference to FIGS. 2-3.

FIG. 2 is a flowchart illustrating a method 200 for presenting healthcare information according to embodiments. Method 200 begins at block 202 by obtaining documents associated with patient care visits, or a general medical history for a patient. The documents to obtain may be determined using a patient name or other identifier associated with the patient. Documents matching the patient name or other identifier are obtained from available information sources such as healthcare provider systems 120 (e.g., hospital, clinics, insurance systems, and other healthcare service providers). The documents are generally clinical documents associated with various visits by the patient to healthcare providers.

At block 204, a system executing the method determines an importance rating for the healthcare visits associated with the documents obtained at block 202. Various factors may be used to determine an importance rating for a visit. For example, in some embodiments, the size or amount of data present in documents for a visit is used to determine an importance factor for the visit. For example, a larger document or set of documents is likely to have more clinical information about a patient visit and therefore the visit may be considered to be more important than a visit with a small document or set of documents.

In alternative embodiments, the set of documents may be analyzed to determine diagnoses or procedures prescribed. For instance, diagnosis codes or procedure codes in the document data may be used to determine an importance factor. As an example, a diagnosis code indicating the patient has cancer may be considered more important than a diagnosis code indicating the patient has the common cold. Similarly, procedure codes may be used to determine the importance of a healthcare visit. For example, a visit having a procedure code indicating a lumpectomy was performed may be considered more important than visit having a procedure code indicating a mole removal was performed.

The importance of a diagnosis code may be influenced by other data or diagnoses codes from the same visit or previous visits. For example, a diagnosis code indicating the patient has the flu may in and of itself not be considered important. However if the patient is elderly or if a diagnosis code from another visit indicates that the patient has a compromised immune system, then a diagnosis code indicating the flu may be considered more important than it otherwise would have. Further, previous diagnoses for a patient can be used to determine when a new or chronic problem is happening. Visits corresponding to treatment of the chronic problem can be considered more important once the chronic problem is established.

Other patient data may be a factor in determining the importance of a visit. Such patient data may include demographic data, such as patient age or patient weight at the time of the visit. Further the overall health of the patient (e.g., smoker vs. non-smoker, etc.) may be used to determine the importance of a healthcare visit. The existence of a chronic health condition during a healthcare visit may increase the importance of the visit. Family history may also be used to determine the importance of a visit. For example, a predisposition to breast cancer etc. may be a factor in determining the importance of a visit related to cancer screening.

Additionally, data from previous procedures may be used to establish when a procedure was first done on a patient and the general frequency that the procedure is performed. Less routine procedures may be more considered more important than procedures that are routinely performed.

Another factor that may be used to determine an importance of a visit is data indicating the treating physician. For example, if the treating physician is considered an expert, or if the treating physician has received extensive training, then the importance rating for visits to such physicians may be determined to be less than visits where the treating physician is not considered an expert or has not had extensive training. Similarly, if the treating physician is treating a condition that is outside the field the treating physician normally practices in, then the importance rating may be more than it would be if the treating physician was treating a condition within the physician's specialty. For example, an obstetrician that is treating an acne condition may be considered a greater importance than a dermatologist that is treating an acne condition. The basis for this is that a physician that that has not had extensive training or is treating a condition outside of the physician's specialty is more likely to make errors in treatment. As a result, it may be more important to review the documents associated with such treatments.

A further factor that may be used to determine the importance of a visit is the type of facility providing the treatment during the visit. For example, treatment provided in a hospital emergency room may be considered a more important visit than treatment provided at a clinic. A specialty of the hospital or clinic may be considered in determining the importance of a healthcare visit. For example, a stay at a cancer hospital may be considered more important than a stay at a non-specialized hospital.

Medications prescribed during a healthcare visit may be used to determine the importance of the visit. For example, a prescription for a cancer or HIV medication may be considered more substantial than a prescription for asthma medications. Data regarding previous medications prescribed for a patient may be used to determine the effect that prescriptions provided during a particular health care visit have on the importance of the visit.

Data regarding other patients may be used in determining an importance of a healthcare visit. For example, data regarding the previous diagnoses of a physician or organization may be used to determine the importance of a visit. Such data can be used to determine if the physician or organization treating the patient has had experience in diagnosing the condition. If the physician or organization is new to the diagnosis, then it is more likely they may be misdiagnosing a condition, rendering the healthcare visit more important than if a specialist that had vast experience in diagnosing the condition had rendered the diagnosis. Similarly, data regarding the number of times a physician or organization had performed a particular procedure may be used to determine the importance of a visit in which the particular procedure is performed on a patient. For example, the number of times a physician or organization has performed a particular procedure is likely to be related to the probability of complications from the procedure. In particular, a healthcare visit where a procedure is performed that is relatively new to the organization or physician is more likely to result in complications. Thus the importance of such a visit is determined to be greater than a visit where a routinely performed procedure is done. Likewise, the number of times a physician or organization has prescribed a particular medication may be relevant in determining whether the physician or organization is likely to better determine the dosage of the medicine to minimize side effects. Thus a visit in which a physician or organization prescribes a medicine that they rarely prescribe may be determined to be more important than a visit in which a routinely prescribed medicine is prescribed for the patient.

A physician's notes during a visit may be analyzed to determine keywords that indicate a visit is important. Further, frequencies of words or phrases in the physician's notes may be compared to the frequency of the words or phrases in the notes for patients in a similar population of patients or a general population of patients. Such frequencies of words or phrases may be used to determine the importance of a patient visit. For example, the appearance of particular keywords, or word or phrases that rarely appear in notes may indicate that the visit was more important.

Any one or more of the above factors may be used to determine the importance of a visit. Further, the factors may be combined to determine an importance rating for a healthcare visit, with different weightings assigned to the various factors. The factors to use and the weightings assigned to the factors may be configured by a user or system administrator. For example, a user interface may be provided by browser application 102 that allows a user to specify which factors to use in an importance rating and to assign weightings to the various factors used to determine an importance rating for a healthcare visit. Additionally, the weightings may be stored as user preferences and applied when the user logs in to browser application 102 or system hosting browser application 102.

At block 206, the system generates commands and data to display a timeline of healthcare visits for the patient. The commands and data may be formatted according to a display command language such as a version of the HTML (Hypertext Markup Language). Alternatively, the commands and data may be graphics commands and data that conform to a graphics standard for communicating with graphics hardware such as DirectX. The embodiments are not limited to any particular format for the commands and data. The timeline may be presented as a horizontal or vertical line from older to newer, or the timeline may be presented in a calendar format. The range of dates for the timeline may be determined from the data itself (e.g., the oldest visit to the most recent visit) or the user may specify a range of dates.

At block 208, the system generates commands and data to display graphical elements representing the healthcare visits on the timeline. Each graphical element may represent a particular visit. For example, a circle may represent a particular healthcare visit, with the circles placed on the timeline in accordance to when the visits occurred. Other shapes besides circles may be used in alternative embodiments. The system determines display characteristics of the graphical element according to the importance rating determined at block 204 used to indicate the importance of the visit. For instance, a visual prominence of a graphical element may be used to indicate the importance of a visit. As an example, a size of the graphical element may be used to indicate importance, with larger graphical elements indicating the visit was more important than visits represented by smaller graphical elements. Other methods of adjusting visual prominence may be used. For example, shading, boldfacing, blinking, highlighting and other mechanisms may be used to indicate the importance of a visit represented by a graphical element. Additionally, other attributes of the graphical element may be used to impart information to the viewer. For example, the color of graphical elements may be used to impart information to the user. In some embodiments, color may be used to indicate where the visit took place. For example, an emergency room visit may be indicated in red, while a routine check-up at a clinic may be indicated in grey. Other attributes that may be used to impart information include shape, shading, cross-hatching etc.

Those of skill in the art having the benefit of the disclosure will appreciate that other display characteristics besides size and color may be used to indicate the importance of a healthcare visit, and are within the scope of the inventive subject matter.

Various operations may be performed by a user interface allowing interaction with the display. For example, in some embodiments, a user can zoom in or out of particular areas of the timeline. Additionally, in some embodiments, a user interface may be used to select one or more graphical elements on the timeline. Upon selection, a viewer application may be launched to view the documents associated with the healthcare visits represented by the graphical elements.

FIG. 3 is a diagram of an example timeline display 300 produced using the systems and methods described above. In the example illustrated in FIG. 3, display 300 includes patient demographic data 302, timeline 304, graphical elements 306-312 and legend 314. Graphical elements 306-312 represent healthcare visits that take place at the time indicated on timeline 304. In the example shown, documents and other data have been analyzed to determine that the visit represented by graphical element 306 is more important than the visit represented by graphical element 308, which in turn has been determined be more important than the visit represented by graphical element 310. Legend 314 provides a key mapping the characteristics of the graphical elements 306-312 to the facility providing the healthcare. In FIG. 3, cross-hatching has been used to differentiate the various facilities for the health care visits. Those of skill in the art will appreciate that color may be used to differentiate the various facilities for the health care visits.

As noted above, a user, in some embodiments, may select graphical elements. In the example shown, a user may select graphical elements 312. Upon such selection, the documents associated with the visits represented by graphical elements 312 (e.g., the four visits occurring between January 2008 and July 2008) may be obtained and viewed in a viewer application.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

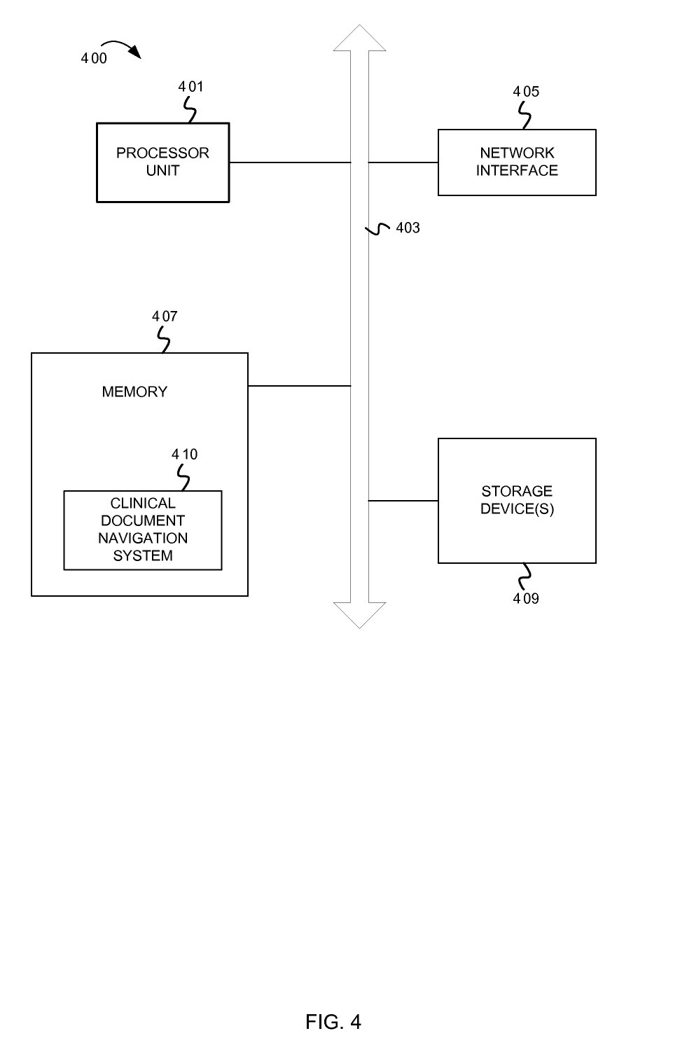

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The system memory 407 embodies functionality to implement embodiments described above. The system memory 407 may include one or more functionalities such as components 410 of clinical document navigation system 100 that facilitate navigating clinical documents as described above. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for navigating clinical documents as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for browsing a collection of clinical documents, the method comprising:
obtaining a plurality of clinical documents for a patient, the clinical documents associated with a plurality of care visits, the care visits including a first care visit and a second care visit;
determining from the plurality of documents a first importance rating for the first care visit and a second importance rating for the second care visit;
generating commands and data for displaying a timeline including graphical elements representing the plurality of care visits, the graphical elements including a first graphical element representing the first care visit and a second graphical element representing the second care visit; and
generating commands and data for displaying the first graphical element and the second graphical element on the timeline in accordance with a time of the first care visit, a time of the second care visit, the first importance rating and the second importance rating.

2. The method of claim 1, and further comprising:
receiving a selection of a subset of the graphical elements representing the plurality of care visits; and
launching an application to browse clinical documents associated with care visits represented by the selected subset of the graphical elements.

3. The method of claim 1, wherein generating commands and data for displaying the first graphical element and the second graphical element further includes generating commands and data for displaying the first graphical element and the second graphical element in accordance with care delivery organizations associated with the first care visit and the second care visit.

4. The method of claim 1, wherein generating commands and data for displaying the first graphical element and the second graphical element includes generating commands and data for displaying the first graphical element and the second graphical element in a color indicating a care delivery organization associated with the first care visit and the second care visit.

5. The method of claim 1, and further comprising determining a visual prominence of the first graphical element in accordance with the first importance rating.

6. The method of claim 5, wherein a greater visual prominence represents a greater importance.

7. The method of claim 5, wherein determining from the plurality of documents the first importance rating for the first care visit and the second importance rating for the second care visit includes determining the first importance rating according to the a size of documents associated with the first care visit and determining the second importance rating according to the size of the documents associated with the second care visit.

8. A computer program product for browsing a collection of clinical documents, the computer program product comprising:
a computer readable storage medium having computer usable program code embodied therewith, the computer usable program code comprising a computer usable program code configured to:
obtain a plurality of clinical documents for a patient, the clinical documents associated with a plurality of care visits, the care visits including a first care visit and a second care visit;
determine from the plurality of documents a first importance rating for the first care visit and a second importance rating for the second care visit;
generate commands and data for displaying a timeline including graphical elements representing the plurality of care visits, the graphical elements including a first graphical element representing the first care visit and a second graphical element representing the second care visit;
generate commands and data for displaying the first graphical element and the second graphical element on the timeline in accordance with a time of the first care visit, a time of the second care visit, the first importance rating and the second importance rating.

9. The computer program product of claim 8, and wherein the computer usable program code further comprises computer usable program code configured to:
receive a selection of a subset of the graphical elements representing the plurality of care visits; and
launch an application to browse clinical documents associated with care visits represented by the selected subset of the graphical elements.

10. The computer program product of claim 8, wherein the computer usable program code configured to generate commands and data for displaying the first graphical element and the second graphical element further includes computer usable program code configured to generate commands and data for displaying the first graphical element and the second graphical element in accordance with care delivery organizations associated with the first care visit and the second care visit.

11. The computer program product of claim 8, wherein the computer usable program code configured to generate commands and data for displaying the first graphical element and the second graphical element includes computer usable program code configured to generate commands and data for displaying the first graphical element and the second graphical element in a color indicating a care delivery organization associated with the first care visit and the second care visit.

12. The computer program product of claim 8, wherein the computer usable program code further comprises computer usable program code configured to determine a visual prominence of the first graphical element in accordance with the first importance rating.

13. The computer program product of claim 12, wherein a greater visual prominence represents a greater importance.

14. The computer program product of claim 12, wherein the computer usable program code configured to determine from the plurality of documents the first importance rating for the first care visit and the second importance rating for the second care visit includes computer usable program code configured to determine the first importance rating according to the a size of documents associated with the first care visit and determining the second importance rating according to the size of the documents associated with the second care visit.

15. An apparatus comprising:
one or more processors; and
a health information server executable by the one or more processors and configured to:
obtain a plurality of clinical documents for a patient, the clinical documents associated with a plurality of care visits, the care visits including a first care visit and a second care visit;
determine from the plurality of documents a first importance rating for the first care visit and a second importance rating for the second care visit;
generate commands and data for displaying a timeline including graphical elements representing the plurality of care visits, the graphical elements including a first graphical element representing the first care visit and a second graphical element representing the second care visit; and
generate commands and data for displaying the first graphical element and the second graphical element on the timeline in accordance with a time of the first care visit, a time of the second care visit, the first importance rating and the second importance rating.

16. The apparatus of claim 15, and wherein the health information server is further configured to:
receive a selection of a subset of the graphical elements representing the plurality of care visits; and
launch an application to browse clinical documents associated with care visits represented by the selected subset of the graphical elements.

17. The apparatus of claim 15, wherein the commands and data for displaying the first graphical element and the second graphical element further includes commands and data for displaying the first graphical element and the second graphical element in accordance with care delivery organizations associated with the first care visit and the second care visit.

18. The apparatus of claim 15, wherein the commands and data for displaying the first graphical element and the second graphical element includes commands and data for displaying the first graphical element and the second graphical element in a color indicating a care delivery organization associated with the first care visit and the second care visit.

19. The apparatus of claim 15, wherein the health information server is further configured to determine a visual prominence of the first graphical element in accordance with the first importance rating.

20. The apparatus of claim 19, wherein a greater visual prominence represents a greater importance.
